(19) United States
(12) Patent Application Publication
(10) Pub. No.: US 2023/0030844 A1
(43) Pub. Date: Feb. 2, 2023

(54) Device to secure an ice cream and a method thereof

(71) Applicants: Ayat Faizan, Irving, TX (US); Mirza Faizan, Irving, TX (US)

(72) Inventors: Ayat Faizan, Irving, TX (US); Mirza Faizan, Irving, TX (US)

(21) Appl. No.: 17/390,999

(22) Filed: Aug. 1, 2021

(51) Int. Cl. B65D 85/78; A23G 9/50

(52) U.S. Cl. CPC B65D 85/78; A23G 9/503

(57) ABSTRACT

A device (10) to secure an ice-cream (12) comprising: a cone-type holder (14) comprises a top portion (14a), a base portion (14b) and a center portion (14c); a base (16), coupled to the top portion (14a) of the cone-type holder (14), comprises a hollow portion (16a) to place the ice-cream (12); a slidable shutter attached to a periphery (16b) of the base (16) to secure the ice-cream (12); and a sensor (20) connected to the cone-type holder (14) to sense a tilt angle of the cone-type holder (14). The center portion (14c) of the cone-type holder (14) is configured to hold the ice cream (12), and said ice-cream (12) is secured in the hollow portion (16b) of the base (16).

### FIELD OF THE INVENTION

The present invention relates to a device to secure an ice-cream and a method thereof. In particular, the present invention relates to a device to secure an ice cream from dripping when opened and a method thereof.

### BACKGROUND OF THE INVENTION

A device of the type mentioned in the field of the invention above is required, in particular, when ice-cream wafer cones are filled with the flavours of ice cream. These wafer cones are provided with paper packaging. However, when these packaging are opened, ice creams inside these packaging start to drip.

As the cones are very fragile, the above-mentioned requirements are very difficult to achieve. In particular, in extremely hot weather, the ice cream tends to melt faster than one can consume it. This is one of the common problems encountered when eating an ice cream cone. Consequently, ice cream tends to run down the side of the cone and onto the consumers' hand creating an unsanitary, sticky mess. At times, the running down ice creams falls on the floors, bed and other things ending up dirtying the surrounding. Also, melted ice cream running down the side of the cone tends to absorb into the cone causing the cone to become soggy, harder to handle, and overall less enjoyable.

The most commonly attempted solution to this problem is to wrap a napkin around the cone. Although using a napkin in this manner may tend to mitigate some of the problems associated with a melting ice cream cone, the napkin absorbs melting ice cream such that the consumer still comes into contact with the ice cream absorbed into the napkin as does the ice cream cone, although perhaps to a lesser degree.

Thus, it is a recurring problem in eating ice cream and other frozen confections on an edible cone is that the ice cream melts and drips down the cone onto the person, clothes or surroundings of the consumer. The dripping or running ice cream results in a sticky, unsanitary situation that interferes with the pleasure of consuming the ice cream.

In order to solve this problem, conventionally, one attempt to remedy the untidiness in consuming melting ice cream in a cone has included wrapping the cone with towels or napkins, particularly towels and napkins made of paper. The problem with these towels and napkins is that they become overly moist with the melting ice cream and begin to stick to the consumer as well as sticking to the cone itself.

Further, conventionally, it is also common to purchase pre-made frozen ice cream cone products that are individually contained in a paper sleeve that encases both the cone and the ice cream thereon. The paper is torn away from the ice cream that tops the cone, while the paper sleeve is left surrounding the cone. These sleeves are no more effective than the napkin because the ice cream simply melts down the side of the paper sleeve creating the same problems.

In response to the problems associated with melting ice cream cones, and due to the fact that the commonly employed napkin and paper sleeve fail to substantially alleviate these problems, various cone holders and drip-collector devices have been developed. However, these prior art devices are somewhat cumbersome, not disposable, and generally impractical to use, and thus they have not met with wide-spread adoption and use.

In order to solve the above mentioned the problem, prior art U.S. Pat. No. 6,237,646 B1 provides an improvement over the prior art in the area of ice cream cone holders and drip collectors. The device for holding an ice cream cone and capable of collecting drips from the ice cream comprising a sleeve having a lower end and an open upper end and shaped for receiving at least a portion of the cone, and a drip catcher including a wall connected to said sleeve, an outer wall extending around said wall, and a spacer wall between said wall and said outer wall, said drip catcher having no surfaces parallel to the vertical plane such that a plurality of the devices may be intimately stacked on and nested within each other.

Yet another prior art is a cone and cone drip guard for preventing melting ice cream from running entirely down the cone and reaching a holder's hand, comprising: a sheet having an outer edge and an inner edge, said inner edge defining a hole in said sheet; a plurality of cone-gripping tabs between said outer edge of said sheet and said inner edge of said sheet, wherein each said cone-gripping tab includes a central fold segment; and a cone extending through the hole defined by said sheet, wherein said plurality of cone-gripping tabs secure said sheet to said cone.

Another prior art U.S. Pat. No. 1,800,759 A provides a device that comprises an ice cream cone, around which I mount a cup. The cup is preferably made cone-shaped so as to act as a support for the ice cream cone. The material forming the cup may be paper, which is waxed for holding the melted cream. The bottom of the cup may be pressed together for forcing the cone upwardly. In this way the cone may be moved upwardly as it is eaten. The cup has a conical-shaped portion that extends away from the upper portion of the cone for providing a catch for the melted cream. The portion is preferably corrugated, and the corrugations provide grooves that extend longitudinally of the cup. These grooves extend past the conical-shaped portion. It is these longitudinal grooves that convey the melted cream to the bottom of the cup and prevent it from over-flowing. These grooves could be dispensed with if the outer surface of the cone were rough, as is the case with many types of cones.

However, there is still a need to overcome the drawbacks of the exisitng art for an ice cream cone holder and drip collector device that can be conveniently packaged in high density or as part of a pre-made frozen ice cream cone product, that is inexpensive to manufacture, that is disposable, that can be quickly dispensed from its packaged arrangement and fitted to the ice cream cone, and that can substantially protect the cone itself from the deleterious effects that melting ice cream tends to have on the cone. The prior art devices, while individually addressing one or more of these concerns, have failed to provide a device that addresses all of them so as to provide a device that is practical for wide spread use. Thus, there exists a need in the art for a device to secure an ice-cream and a method thereof that incorporates all of the above-referenced characteristics and overcomes the problems of prior art, and such a device is disclosed herein.

### OBJECTS OF THE INVENTION

The main object of the present invention is to provide a device to secure an ice-cream and a method thereof.

Another object of the present invention is to provide an improved device to secure an ice cream that has sensors for automatic commands to secure the dripping of ice cream.

Another object of the present invention is to provide a device for securing ice creams that reduces sticky mess created by ice cream that runs down the side of the cone and onto the consumers' hand, floors, bed and other things.

### SUMMARY OF THE INVENTION

In order to solve the drawbacks of the prior art, the present invention provides a device to secure an ice cream and a method thereof.

According to an embodiment of the present invention, the device to secure an ice-cream comprising: a cone-type holder comprises a top portion, a base portion and a center portion; a base, coupled to the top portion of the cone-type holder, comprises a hollow portion to place the ice-cream; a slidable shutter attached to a periphery of the base to secure the ice-cream; and a sensor connected to the cone-type holder to sense a tilt angle of the cone-type holder.

In some embodiments of the present invention, the center portion of the cone-type holder is configured to hold the ice-cream.

In some embodiments of the present invention, said ice-cream is secured in the hollow portion of the base.

In some embodiments of the present invention, the sensor is connected to the slidable shutter.

In some embodiments of the present invention, the slidable shutter is configured to receive commands from said senor.

In some embodiments of the present invention, the slidable shutter is a two-portion shutter in oval shape.

In some embodiments of the present invention, one portion of the two portions of the slidable shutter is configured to slide back to the other portion to release the ice-cream for eating.

In some embodiments of the present invention, said sensor is configured to determine that the tilt angle of the cone-type holder is equal to or greater than 70°.

In some embodiments of the present invention, when said sensor determines that the tilt angle of the cone-type holder is equal to or greater than 70°, said sensor sends the command to the slidable shutter to secure the ice-cream.

In some embodiments of the present invention, when said slidable shutter receives the command from the sensor to secure the ice-cream, said one portion from the two portions of the slidable shutter that has slid back comes back to its original position forming the oval shape to secure the ice-cream.

According to an embodiment of the present invention, a method to secure an ice-cream comprising: placing the ice-cream in a base of a cone-type holder; providing a slidable shutter on a periphery of the base to secure the ice-cream; and monitoring a tilt-angle of the cone-type holder using a sensor.

In some embodiments of the present invention, the slidable shutter is a two-portion shutter in oval shape.

In some embodiments of the present invention, when eating the ice-cream, one portion of the two portions of the slidable shutter slides back to the other portion.

In some embodiments of the present invention, the method to secure an ice-cream further comprising: determining that the tilt angle of the cone-type holder is equal to or greater than 70°; and when said sensor determines that the tilt angle of the cone-type holder is equal to or greater than 70°, sending the command to the slidable shutter to secure the ice-cream.

In some embodiments of the present invention, said one portion from the two portions of the slidable shutter that has slid back comes back to its original position forming the oval shape to secure the ice-cream.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a device to secure an ice-cream in open state according to an embodiment of the present invention.

FIG. 2 is a device to secure an ice-cream in closed state according to an embodiment of the present invention.

Persons skilled in the art will appreciate that elements in the figures are illustrated for simplicity and clarity and may not have been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF DRAWINGS

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skills in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below. Embodiments of the present invention will be described below in detail with reference to the accompanying drawings.

Embodiments of the present invention will be described below in detail with reference to the accompanying drawings.

It will be understood by those skilled in the art that the foregoing general description and the following detailed description are explanatory of the invention and are not intended to be restrictive thereof.

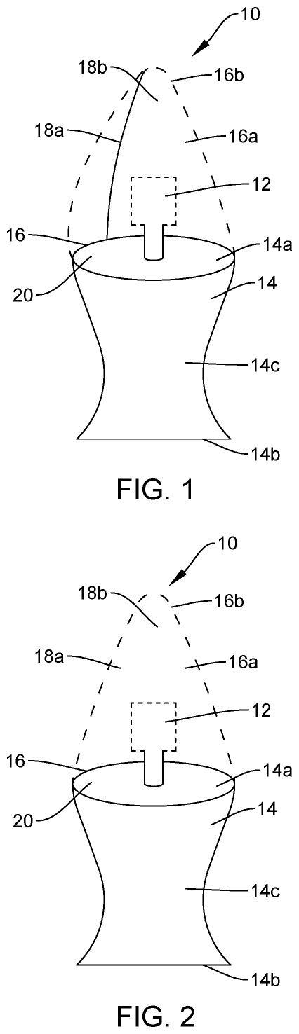

FIG. 1 is a device (10) to secure an ice-cream (12) in open state according to an embodiment of the present invention. In some embodiments, the device (10) to secure an ice-cream (12) comprises a cone-type holder (14) comprises a top portion (14a), a base portion (14b) and a center portion (14c). The cone-type holder (14) may be made of metal or non-metallic frame as suitable for the purpose. In some embodiments, the device (10) to secure an ice-cream (12) further comprises a base (16) comprises a hollow portion (16a) to place the ice-cream (12). In some embodiments, the base (16) is coupled to the top portion (14a) of the cone-type holder (14). In some embodiments, the device (10) to secure an ice-cream (12) further comprises a slidable shutter attached to a periphery (16b) of the base (16) to secure the ice-cream (12). In some embodiments, the device (10) to secure an ice-cream (12) further comprises a sensor (20) connected to the cone-type holder (14) to sense a tilt angle of the cone-type holder (14).

According to an embodiment of the present invention, the slidable shutter attached to a periphery (16b) of the base (16) to secure the ice-cream (12) may be two-portions shutter (18a, 18b) in oval shape covering the periphery (16b) of the base (16) in a closed loop. In some embodiments, the slidable shutter attached to a periphery (16b) of the base (16) to secure the ice-cream (12) may be more than two-portions shutter (18a, 18b) in petal shapes covering the periphery (16b) of the base (16) in a closed loop or a closed state. In some embodiments, the slidable shutter attached to a periphery (16b) of the base (16) to secure the ice-cream (12) may be flower shaped shutter (18a, 18b) having petal shaped wings covering the periphery (16b) of the base (16) in a closed loop.

In some embodiments, the base (16) is coupled to the top portion (14a) of the cone-type holder (14). In some embodiments, the center portion (14c) of the cone-type holder (14) is configured to hold the ice cream (12). In some embodiments, the ice cream (12) is secured in the hollow portion (16b) of the base (16). In some embodiments, the base (16) of the device (10) is further configured to collect the dripped ice cream so that the ice cream does not fall on consumers' hand or floor. In some embodiments, the base (16) may be made of a metallic or non-metallic properties.

In some embodiments, the base (16) is coupled to the top portion (14a) of the cone-type holder (14). In some embodiments, the center portion (14c) of the cone-type holder (14) is configured to hold the ice cream (12). In some embodiments, the ice cream (12) is secured in the hollow portion (16b) of the base (16). In some embodiments, the base (16) of the device (10) is further configured to collect the dripped ice cream so that the ice cream does not fall on consumers' hand or floor.

In some embodiments, the base may be connected to a senor (20). In some embodiments, the sensor (20) is connected to the slidable shutter. In some embodiments, the device (10) to secure an ice cream (12) may comprise of a plurality of sensors (20). In some embodiments, the sensors (20) may be an inclinometer. The inclinometer is an instrument used for measuring angles of slope (or tilt), elevation, or depression of an object with respect to gravity's direction. It is also known as a tilt indicator, tilt sensor, tilt meter, slope alert, slope gauge, gradient meter, gradiometer, level gauge, level meter, declinometer, and pitch & roll indicator. The tilt sensor (20) can measure the tilting of the cone holder (12) or the device (10) so that if the angle of tilt is close to normal, then the chances of dripping the ice cream are more. Preferably, in some embodiments, the at least one sensor (20) is configured to determine the tilt angle of the cone-type holder (14). In some embodiments, the at least one sensor (20) is configured to determine that the tilt angle of the cone-type holder (14) is equal to or greater than 70°. In some embodiments, when said sensor (20) determines that the tilt angle of the cone-type holder (14) is equal to or greater than 70°, the sensor (20) sends the command to the slidable shutter to secure the ice cream (12).

According to an embodiment of the present invention, the slidable shutter is configured to receive commands from the senor(s) (20). Further, as shown in Figure, 1, according to an embodiment of the present invention, one portion (18a) of the two portions of the slidable shutter is configured to slide back to the other portion (18b) to release the ice-cream (12) for eating, i.e., the open state of the device.

As shown in FIG. 2, the slidable shutter is two-portions shutter (18a, 18b) in oval shape covering the periphery (16b) of the base (16) in the closed state. When the slidable shutter receives the command from the sensor (20) to secure the ice-cream (12), the one portion (18a) from the two portions (18a, 18b) of the slidable shutter that has slid back comes back to its original position forming the oval shape to secure the ice-cream (12). In some embodiments, the device (10) is enabled with sensors (20) to provide automatic securing of ice creams.

According to an embodiment of the present invention, a method to secure an ice cream comprises placing the ice-cream in a base of a cone-type holder. According to an embodiment of the present invention, the method to secure an ice cream further comprises providing a slidable shutter on a periphery of the base to secure the ice-cream. In some embodiments, the slidable shutter is a two-portion shutter in oval shape. According to an embodiment of the present invention, the method to secure an ice cream further comprises monitoring a tilt-angle of the cone-type holder using a sensor. In some embodiments, when eating the ice cream, one portion of the two portions of the slidable shutter slides back to the other portion.

According to an embodiment of the present invention, the method to secure an ice-cream further comprise determining that the tilt angle of the cone-type holder is equal to or greater than 70°. The method to secure an ice cream further comprise, when said sensor determines that the tilt angle of the cone-type holder is equal to or greater than 70°, sending the command to the slidable shutter to secure the ice-cream. In some embodiments, the one portion from the two portions of the slidable shutter that has slid back comes back to its original position forming the oval shape to secure the ice cream.

Moreover, the actions of any components in the block diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments.

We claim:

1. A device (10) to secure an ice-cream (12) comprising:
a. a cone-type holder (14) comprises a top portion (14a), a base portion (14b) and a center portion (14c);
b. a base (16), coupled to the top portion (14a) of the cone-type holder (14), comprises a hollow portion (16a) to place the ice-cream (12);
c. a slidable shutter attached to a periphery (16b) of the base (16) to secure the ice-cream (12); and
d. a sensor (20) connected to the cone-type holder (14) to sense a tilt angle of the cone-type holder (14),
wherein the center portion (14c) of the cone-type holder (14) is configured to hold the ice-cream (12), and
wherein said ice-cream (12) is secured in the hollow portion (16b) of the base (16).

2. The device (10) to secure an ice-cream (12) as claimed in claim 1, wherein the sensor (20) is connected to the slidable shutter.

3. The device (10) to secure an ice-cream (12) as claimed in claim 1, wherein the slidable shutter is configured to receive commands from said senor (20).

4. The device (10) to secure an ice-cream (12) as claimed in claim 3, wherein the slidable shutter is two-portions shutter (18a, 18b) in oval shape covering the periphery (16b) of the base (16) in a closed loop.

5. The device (10) to secure an ice-cream (12) as claimed in claim 4, wherein one portion (18a) of the two portions of the slidable shutter is configured to slide back to the other portion (18b) to release the ice-cream (12) for eating.

6. The device (10) to secure an ice-cream (12) as claimed in claim 5, wherein, said sensor (20) is configured to determine that the tilt angle of the cone-type holder (14) is equal to or greater than 70°.

7. The device (10) to secure an ice-cream (12) as claimed in claim 6, wherein, when said sensor (20) determines that the tilt angle of the cone-type holder (14) is equal to or greater than 70°, said sensor (20) sends the command to the slidable shutter to secure the ice-cream (12).

8. The device (10) to secure an ice-cream (12) as claimed in claim 7, wherein, when said slidable shutter receives the command from the sensor (20) to secure the ice-cream (12), said one portion (18a) from the two portions (18a, 18b) of the slidable shutter that has slid back comes back to its original position forming the oval shape to secure the ice-cream (12).

9. A method to secure an ice-cream comprising:
a. placing the ice-cream in a base of a cone-type holder;
b. providing a slidable shutter on a periphery of the base to secure the ice-cream, wherein the slidable shutter is a two-portion shutter in oval shape; and
c. monitoring a tilt-angle of the cone-type holder using a sensor,
wherein, when eating the ice-cream, one portion of the two portions of the slidable shutter slides back to the other portion.

10. The method to secure an ice-cream as claimed in claim 9 further comprising:
a. determining that the tilt angle of the cone-type holder is equal to or greater than 70°; and
b. when said sensor determines that the tilt angle of the cone-type holder is equal to or greater than 70°, sending the command to the slidable shutter to secure the ice-cream,
wherein said one portion from the two portions of the slidable shutter that has slid back comes back to its original position forming the oval shape to secure the ice-cream.
